(19) United States
(12) Patent Application Publication
(10) Pub. No.: US 2010/0017294 A1
(43) Pub. Date: Jan. 21, 2010

(54) EMAIL ADVERTISEMENT SYSTEM AND METHOD

(75) Inventors: Robert Mancarella, Portsmouth, NH (US); Rick Blaisdell, Stratham, NH (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: MAILMETHODS, LLC, Stratham, NH (US)

(21) Appl. No.: 12/358,284

(22) Filed: Jan. 23, 2009

Related U.S. Application Data
(60) Provisional application No. 61/023,138, filed on Jan. 24, 2008.

(51) Int. Cl. G06Q 30/00; G06F 15/16

(52) U.S. Cl. 705/14.55; 709/206; 705/14.49

(57) ABSTRACT

An outgoing email server inserts electronic advertisements in outgoing email messages. The server creates enhanced email messages in which the original plain email message text is framed with one or more electronic advertisements, as well as banners or footers related to the company or organization where the email author is employed. The system allows the assignment of one or more keywords to each electronic advertisement to facilitate the placing of electronic advertisements on a contextual basis. The preferred system searches the text of the outgoing email message for the one or more keywords assigned to the electronic advertisement. In another aspect, the system uses a database including email addresses for prospective recipients and assigns targeting words to those email addresses. If these targeting words match the keywords assigned to the advertisement, the advertisement will be placed. The system also allows electronic advertisements to be placed on a static or rotating basis. In addition, the system provides means for selecting and designing electronic advertisement campaigns using the above techniques.

### CROSS-REFERENCE TO RELATED APPLICATION

This application is based on and claims priority from U.S. Provisional Patent Application Ser. No. 61/023,138 filed on Jan. 24, 2008.

### FIELD OF THE INVENTION

The invention relates to one-to-one (versus one-to-many) electronic email advertising systems and methods. In particular, the invention relates to the ability to frame outgoing email messages with advertisements targeted to the intended recipient.

### BACKGROUND OF THE INVENTION

Electronic mail or email is widely used to communicate information from one person to another. It is not uncommon for businesses or other organizations to provide email access to many if not all employees. Many companies or organizations also use email to transact business or to market to their customers and perspective customers. For example, many companies send a single email message with advertising and other marketing content to promote products or services to a large number of customers or potential customers. This technique is known as a one-to-many email marketing campaign. One of the drawbacks these s systems is that recipients often ignore the advertisements, even if the content is relevant to the recipient's interest.

In contrast to one to many email campaigns, it is also known in the prior art to frame or wrap email messages with electronic advertising. An example of such a system is Google's gmail™ which frames incoming email with advertising links based at least in part on the content of the email. When the recipient opens the email message, the message is surrounded or framed by advertisements having a URL link to a website. If one of the advertisements captures the recipient's interest, and the recipient clicks on the URL link, it will typically route the recipient to the advertiser's website. The intent is that the advertisements be targeted to the content of the incoming email messages; however, the sender of the email message has little or no control over the advertisements or marketing campaigns that are presented to the recipient of the email message.

Some email systems are designed to serve advertisements or other marketing information as well as company logos or banners, along with outgoing email messages. One such system is disclosed in U.S. Patent Application US 2007/00083602 A1 entitled “Method, System and Software for Dynamically Extracting Content for Integration with Electronic Mail”, filed on Oct. 5, 2006 and published on Apr. 12, 2007. Such outgoing email advertisement serving systems allows a business or organization to implement consistent branding campaigns, and present advertising and marketing promotions which wrap outgoing email messages sent from employees to outsiders. With such outgoing email message systems, it is believed that placed advertisements are more likely to draw the attention of email recipients because the recipient is already engaged in dialogue with the company or organization sending the email message. Of course, such systems may not be particularly effective unless the system has the ability to effectively target advertising to the recipient's immediate interest. Some larger companies use sophisticated customer identification databases to correlate the customer's past behavior and demographics to product purchasing behavior and advertising campaigns and marketing promotions. However, such systems tend to be quite expensive and time consuming to implement.

Some prior art systems track whether individual advertisements have been placed in received email messages, as well as whether presented advertisements have been converted (i.e., the URL link has been chosen so that the email recipient visits the advertiser's website). In some systems, this information is used for billing purposes. Whether or not this information is used for billing purposes, this information can be quite useful to marketing personnel when designing advertising campaigns and promotions.

It is an object of the invention to provide an improved outgoing email system that serves targeted advertisements or other marketing promotions in one-to-one email messages. It is desired that the system be relatively easy to install and implement, while at the same time provide the opportunity to facilitate highly targeted advertising campaigns, thereby increasing the likelihood of conversion of the presented advertisements and/or marketing promotions.

### SUMMARY OF THE INVENTION

The invention relates to email advertising systems and methods which create enhanced email messages by supplementing original outgoing email messages with one or more electronic advertisements. An outgoing email server, such as an SMTP server, contains software to facilitate the programming and effectiveness of the advertising campaigns. For example, in the preferred embodiment the outgoing email server contains software for preparing electronic advertisements and storing the prepared advertisements on the server, for designing and selecting advertising campaigns, and for creating enhanced outgoing email messages which include one or more electronic advertisements from the selected advertising campaign, as well as software for implementing other functions described herein.

In one aspect, the invention is a method of, and system for, selecting highly targeted electronic advertisements for insertion into outgoing email messages. In this aspect, at least one advertising campaign containing a plurality of electronic advertisements is stored on the outgoing mail server. One or more keywords are assigned to at least one of the electronic advertisements stored on the outgoing server. Preferably, the keyword(s) is(are) assigned by a person in charge of creating the advertising campaign, such as a marketing manager. Email users prepare outgoing email messages in the typical course, for example using an email client such as Microsoft Outlook™. The plain email message is sent from the email client and received by the outgoing mail server either directly or indirectly. The plain email message can take the form of plaint text, rich text, html and could include images as well. The outgoing mail server contains software to search the content of the plain email message for the keywords assigned to the various electronic advertisements stored on the outgoing server. If a keyword associated with an electronic advertisement appears in the text of the plain outgoing email message, the outgoing mail server creates an enhanced outgoing email message in which the original content of the plain email message is supplemented with at least the electronic advertisement to which the keyword is assigned. The enhanced email message is then sent to the recipient with the electronic advertisement to which the keyword is assigned presented in the email message, preferably as a portion of a frame, when the recipient opens the email message. This tool facilitates the ability to supplement outgoing email message with electronic advertisements that are not only selected from a pool of advertisements selected by the business, but also most relevant to the content of outgoing email messages. For example, it is contemplated that most if not all emails from an individual business be keyword searched and electronic advertisements inserted appropriately, thereby providing a targeted and consistent advertising campaign to all email recipients.

In accordance with the invention, however, the selection of the electronic advertisements for a particular advertising campaign may be selected in other ways as well. In the preferred embodiment of the invention, the system is able to present up to five advertisements in the enhanced outgoing email message, as well as a top and bottom banner which may be useful for providing company logos, letterhead information or the like. In the event that one or more keywords assigned to the electronic advertisement are not present in that outgoing email, it is preferred that the system provide the option to default to selecting electronic advertisements from a group of advertisements on a rotating basis.

In another aspect of the invention, the system includes a user database containing email addresses for prospective email recipients along with one or more targeting words. The outgoing email server has software that determines whether the email message is being sent to a prospective email recipient listed in the user database, and if so determines whether the one or more targeting words associated with the recipient email address match keyword assigned to an advertisement in the campaign. If there is a match, the electronic advertisement is inserted into the outgoing enhanced email message. Again, in the event that there is no match, it is preferred that the system default to selecting an advertisement from a group on a rotating basis.

It is further preferred that the system also allow advertising campaigns that place advertisements in outgoing email messages on a static and a rotating basis. If an advertisement is designated to be static, it will be added to each enhanced outgoing email message. To implement the rotating option, a plurality of electronic advertisements is placed in a group, and the system picks an electronic advertisement to be placed in the outgoing email message on a rotating basis from the group.

In another aspect of the invention, the system also allows a user to store multiple advertising campaigns, each typically being programmed according to the above-described programming options (e.g. keyword, user database targeting, static, and rotating). Yet, each campaign would typically include different advertisements and/or different logic for placing individual advertisements. In this aspect, the system preferably includes a set of rules which are tested against header information in the outgoing email message to determine which advertising campaign applies to the particular outgoing email message. The system preferably tests each of the campaigns in a priority order, and the first matching campaign is selected. The first advertising campaign for which the header information satisfies each and every rule is selected for the particular outgoing email message. Preferably, the advertising campaign selection rules include the following categories: enhanced subject, enhanced subject code, ignore subject, enhanced from, enhanced to, ignore from, ignore to. For example, if the header information in an outgoing email message includes a word matching one listed in the category for enhanced subject and otherwise meets all of the other criteria for the other categories, the associated advertising campaign will be selected.

The system also preferably includes global settings for outgoing email messages from an account having many email users. In particular, it is preferred that the global settings include the ability to send a plain email message to the intended recipient without enhancement under certain conditions. For example, it is preferred that the global settings include the following categories: never enhanced subject, never enhanced subject code, never enhanced from, never enhanced to. This feature can be used, for example, to turn off the software for all emails from members of a company's legal department, or all emails sent to certain individuals. Also, a never enhanced subject code, such as “no ads” can be placed in the subject line in order to avoid email enhancements for a specific outgoing email message.

In another aspect, the preferred system provides screens to help the system user, such as a marketing manager, prepare images and texts for electronic advertisements in a format that is suitable for placement in enhanced email messages. Preferably, most advertisements will include an associated destination URL such that the recipient of the enhanced email message will be directed to the destination URL if the recipient selects advertisement after the enhanced email message has been delivered to the recipient. More specifically, in the preferred embodiment, the recipient will be directed first to the outgoing email server for tracking purposes, and then to the destination URL. The preferred system has the ability to provide reports regarding advertisement placement and conversion (or click throughs), which may be useful information for marketing departments.

The preferred system also provides the ability to prepare a landing page consisting of images and/or text, and associate the landing page with a prepared advertisement in lieu of associating a destination URL. This feature may be useful, e.g., for placing advertisements for companies or products not having a website, or at least a pertinent website for the specific promotion.

The system as described provides much flexibility for marketing managers to develop advertising campaigns, and deliver targeted advertisements along with outgoing one-to-one email messages sent from the company or organization. Each advertising campaign can implement different layouts, different banners and footers, different logic for placing targeted and/or static or rotating advertisements. While the setup for the advertising campaigns need not be extremely complex, it has been found that some users may prefer a simplified system. In this regard, one embodiment of the invention provides a system that is limited to only one advertising campaign consisting of a standard layout for the banner and footer and electronic advertisements. All the electronic advertisements that are prepared are stored in a group on the server. The electronic advertisements, as discussed above, can include a link to a destination URL, or a link to a landing page. Preferably, the system will place five electronic advertisements in the enhanced outgoing email, assuming that there are at least five stored advertisements in the group. One or more keywords can be assigned to each electronic advertisement in the group as discussed above. Preferably, the system selects the appropriate electronic advertisements based on whether the one or more keywords assigned to the respective advertisements appear in the email message received by the outgoing email server. If not, the system selects an electronic advertisement from the group on a rotating basis. Whether an advertisement is selected based on keyword, or on a rotating basis from the group as a default, the system does not allow duplicate advertisements.

Other features and aspects of the invention may be apparent to those skilled in the art upon reviewing the following drawings and description thereof.

### BRIEF DESCRIPTION OF THE DRAWINGS

FIG. 1A illustrates a plain, outgoing email message prepared with email client software.

FIG. 1B illustrates an enhanced email message having an electronic banner and footer, and electronic advertisements framing the text of the email message of FIG. 1A, created in accordance with the preferred embodiment of the invention as would be viewed by the recipient of the message.

FIG. 2 is a perspective view of a hardware appliance used to implement a preferred embodiment of the invention.

FIG. 3A is a diagram illustrating the typical setup and operation of the invention in a situation where an organization creating and sending the email messages does not have a dedicated exchange server.

FIG. 3B is a diagram illustrating the typical setup and operation of the invention in a situation where an organization preparing and sending outgoing email messages has a dedicated exchange server.

FIG. 4 is a block diagram illustrating the general functions of software implementing the preferred embodiment of the invention.

FIG. 5 shows a screen for entering global settings in accordance with the preferred embodiment of the invention.

FIG. 6 is a software screen illustrating a menu for designing electronic advertisements and campaigns which are used to create enhanced outgoing email messages as shown in FIG. 1B.

FIG. 7 shows an advertisement campaign design screen in accordance with a preferred embodiment of the invention.

FIG. 8 shows a layout design screen in accordance with a preferred embodiment of the invention.

FIG. 9A illustrates a text advertisement development screen in accordance with the preferred embodiment of the invention.

FIG. 9B shows an image advertisement development screen in accordance with the preferred embodiment of the invention.

FIG. 9C shows an HTML advertisement development screen in accordance with a preferred embodiment of the invention.

FIG. 10 shows an advertisement group selection screen in accordance with the preferred embodiment of the invention.

FIG. 11 shows a menu screen illustrating the various categories of reports available in the preferred embodiment of the invention.

FIG. 12 illustrates one of the report screens available in the preferred embodiment of the invention.

FIG. 13 shows a company setup screen, and in particular, shows that the company has chosen the basic account option.

FIG. 14 is a basic account setup screen.

### DETAILED DESCRIPTION OF THE DRAWINGS

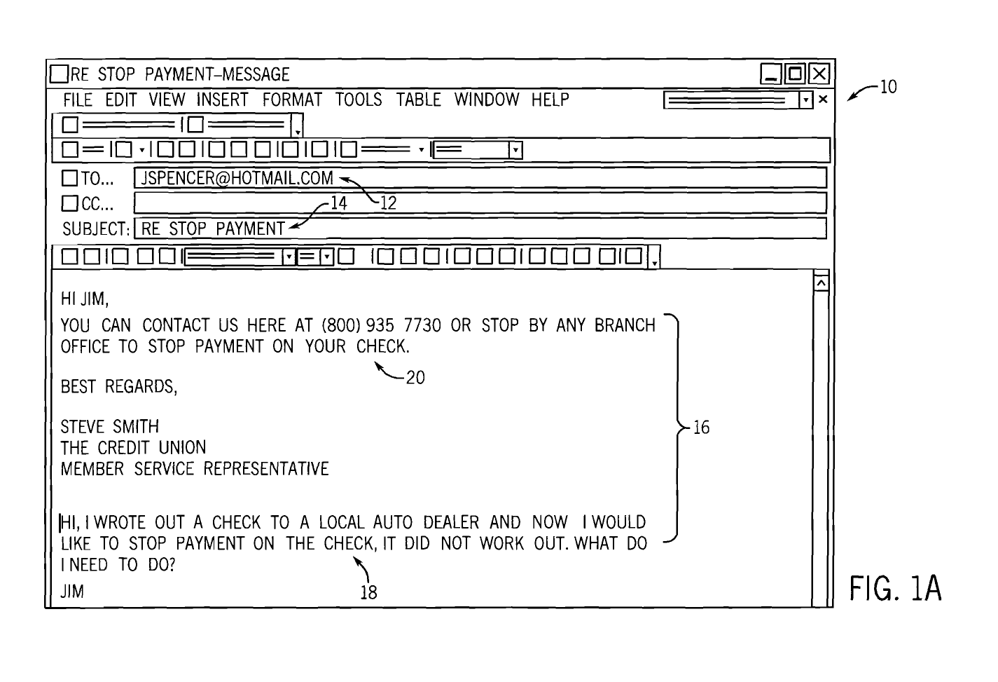

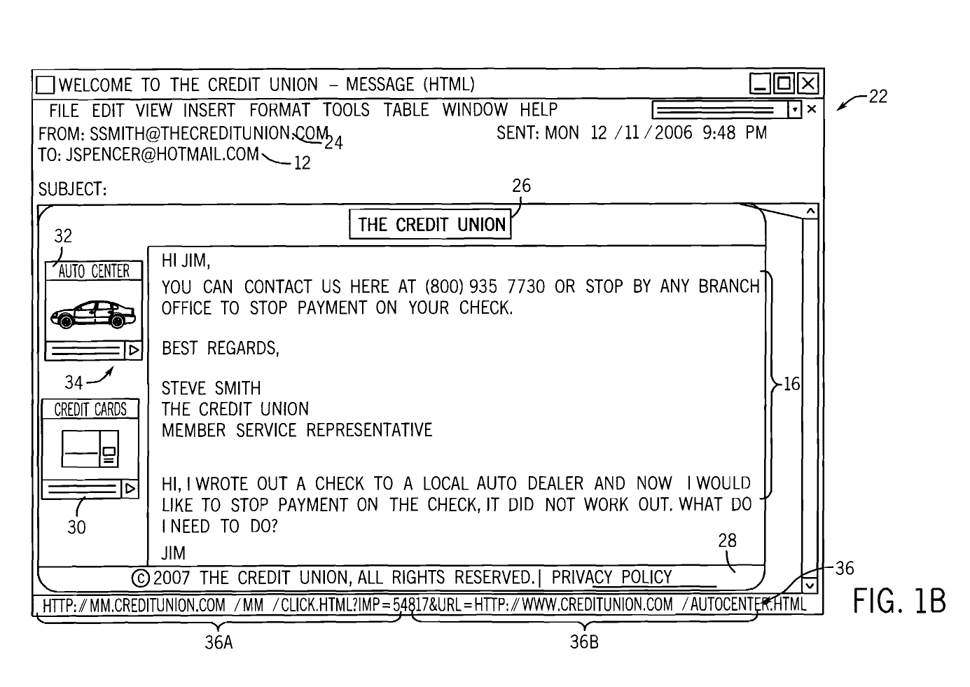

FIG. 1A illustrates a plain, outgoing email message that has been prepared with email client software, for example residing on an email user's personal computer, or on an organization's exchange server. In particular, FIG. 1A illustrates a reply email message prepared using Microsoft Outlook™. The outgoing email is addressed to an intended recipient, as illustrated by reference number 12. As is known in the art, the intended recipient's email address consists of a user name, e.g. “jspencer” that precedes the @ symbol, and a domain name “hotmail.com” which follows the @ symbol. The email header also includes a description of the subject matter of the email, as illustrated by reference number 14. The body 16 of the outgoing email message includes plain text and/or HTML text which in the case of FIG. 1A is written personally. In the email string in FIG. 1A, a credit union customer had written a message 18 to a credit union employee, and the credit union employee has prepared a reply email to the customer using email client software. Both the text of the initial email message 18 from the customer and the return email message 20 from the employee are contained within the text portion of the reply email message 16. Note that the subject matter of the email 16 deals with a local auto dealer on one hand, and stopping payment on a check on the other hand.

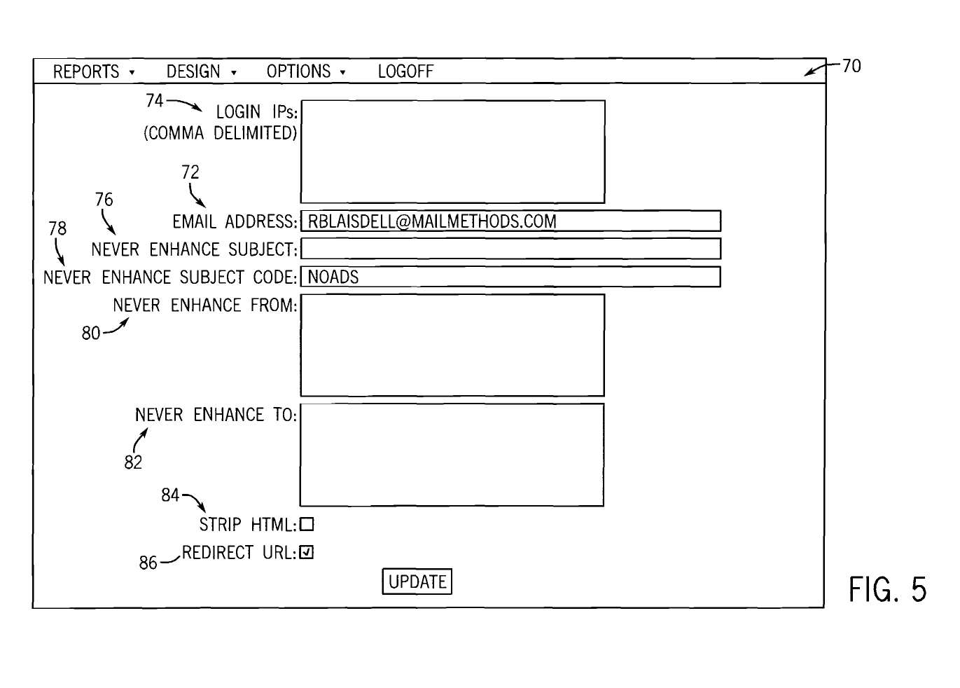

FIG. 1B illustrates the same email message as shown in FIG. 1A after it has been enhanced in accordance with the invention, delivered to the intended recipient 12, opened for reading. The author's email address 24 appears on the recipient's screen, as is known in the art. In accordance with the invention, the plain text of the original email 16 is framed by an electronic banner 26, an electronic footer 28, and electronic advertisements 30 and 32. The specific physical layout of the banner 26, the footer 28 and the advertisements 30, 32 is flexible. In the disclosed embodiment, the banner 26 and footer 28 are static, meaning that they are placed in the same form in all outgoing enhanced email messages sent from the organization's domain, unless the system opts out per the global settings, as discussed in more detail with respect to FIG. 5. The consistent use of banner 26 and footer 28 allows an organization to provide consistent branding on all or virtually all of its outgoing email correspondence, much like a company's letterhead.

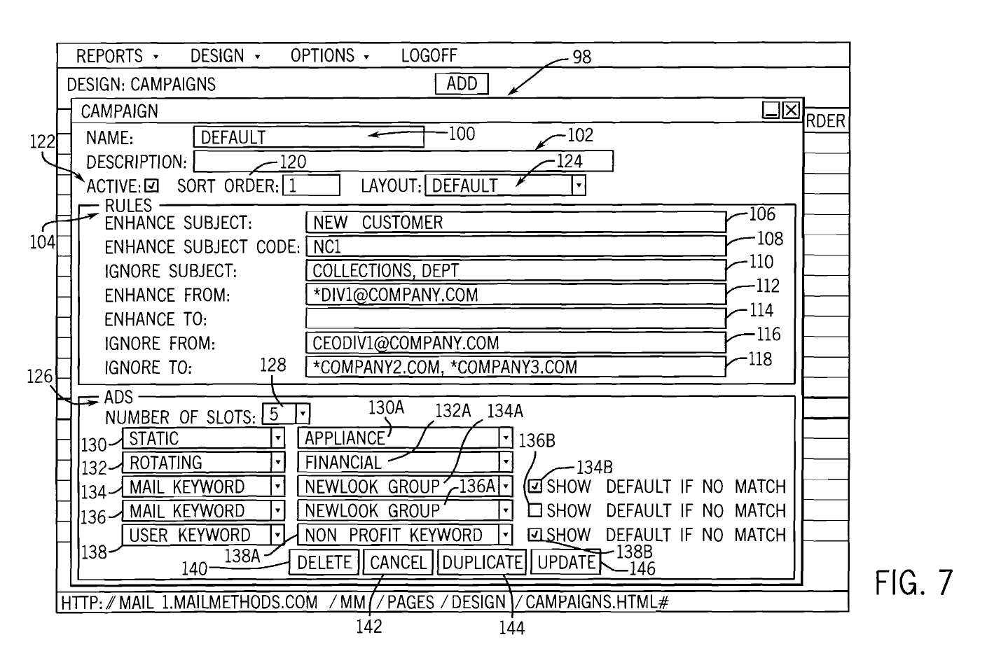

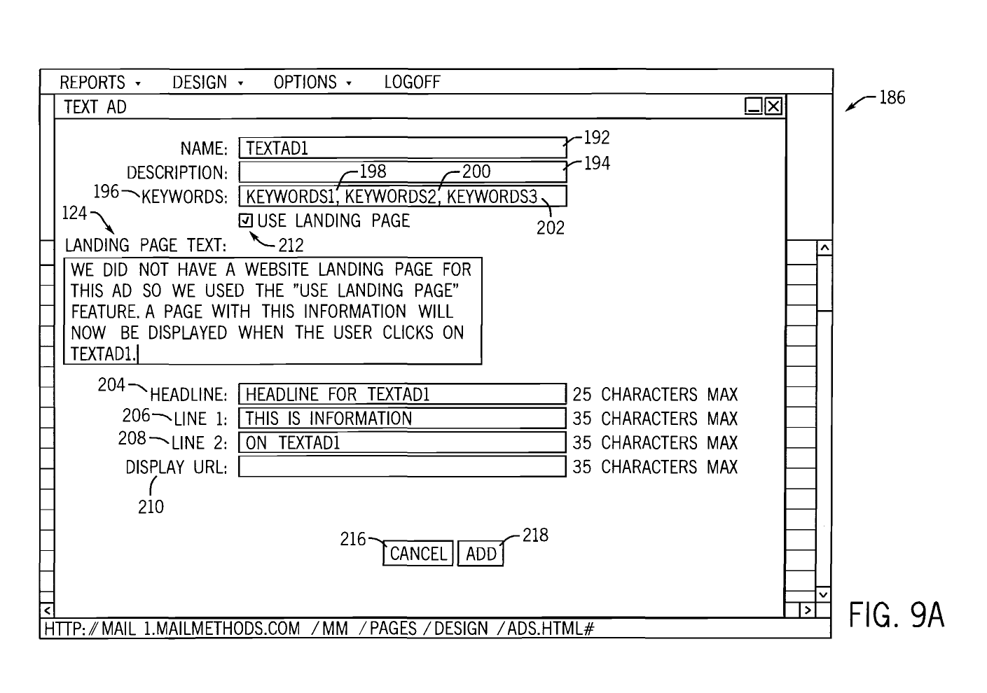

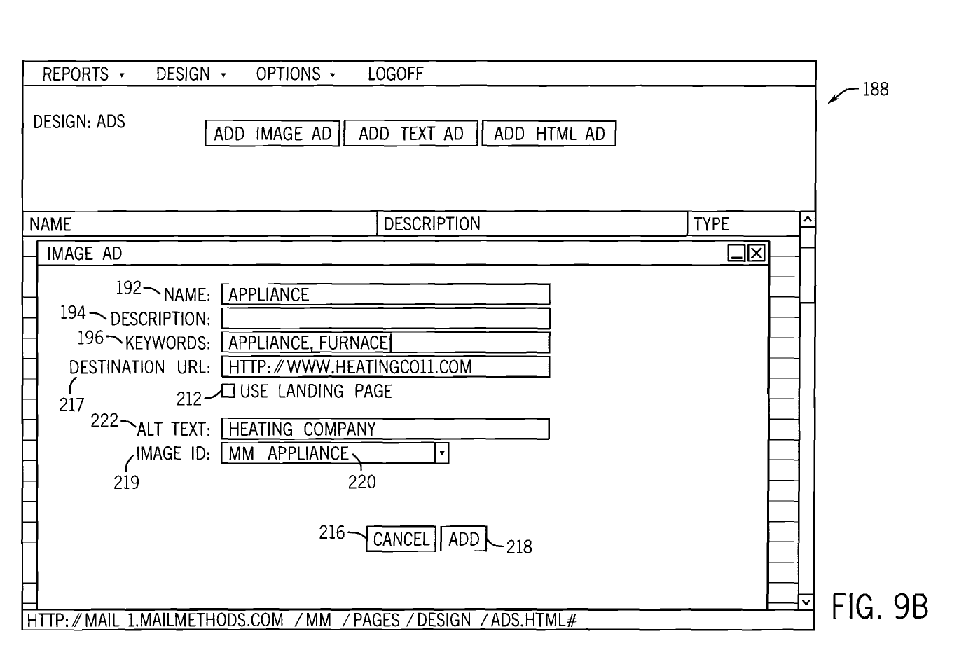

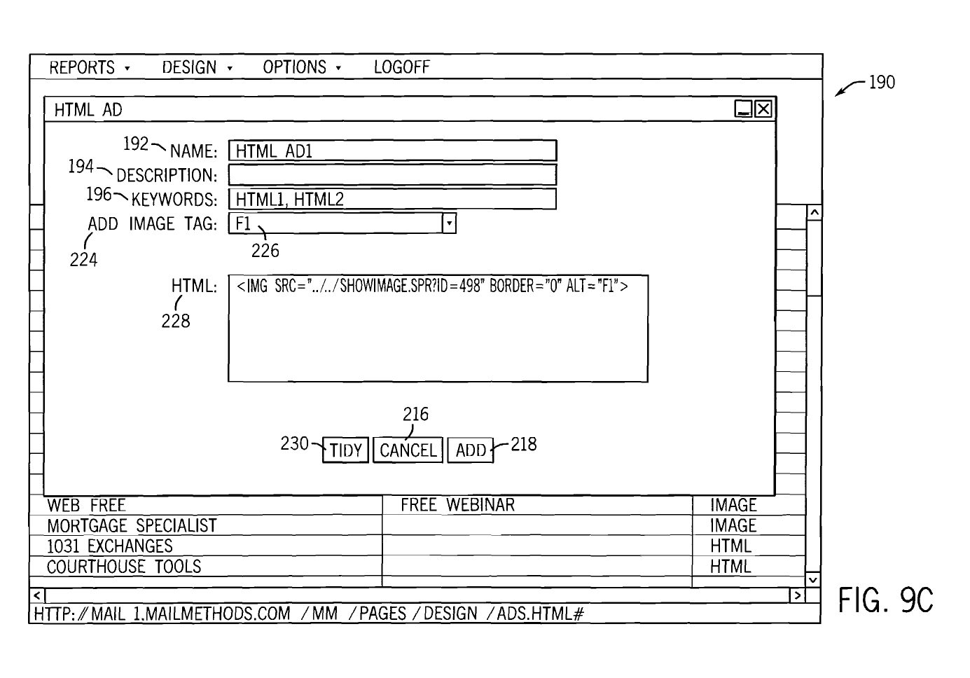

The electronic advertisements 30, 32 are inserted into the enhanced email message 22 according to campaign rules discussed below with respect to FIG. 7. The content of the electronic advertisements 30, 32, their creation and their inclusion into the system are discussed primarily with respect to FIGS. 9A-9C. Briefly, in accordance with the invention, the electronic advertisements 30, 32 are targeted to the content of the email text 16, and/or targeted to the recipient 12, or placed on a static basis or a rotating basis. The advertisements 30, 32 are also preferably associated with a URL link (or associated with a landing page, as described hereinafter) that will redirect the recipient to a specific website when the recipient selects or “clicks” a particular electronic advertisement 30, 32 framing the enhanced email message 22. In FIG. 1B, the cursor 34 is pointing to the top electronic advertisement 32, and the bottom of the screen displays the redirected URL address 36. Note that the URL address 36 directs the recipient to the enhanced outgoing email advertisement server 38 for tracking purposes, as indicated by reference number 36A, and then forwards the recipient to the ultimate destination website, as indicated by reference number 36B.

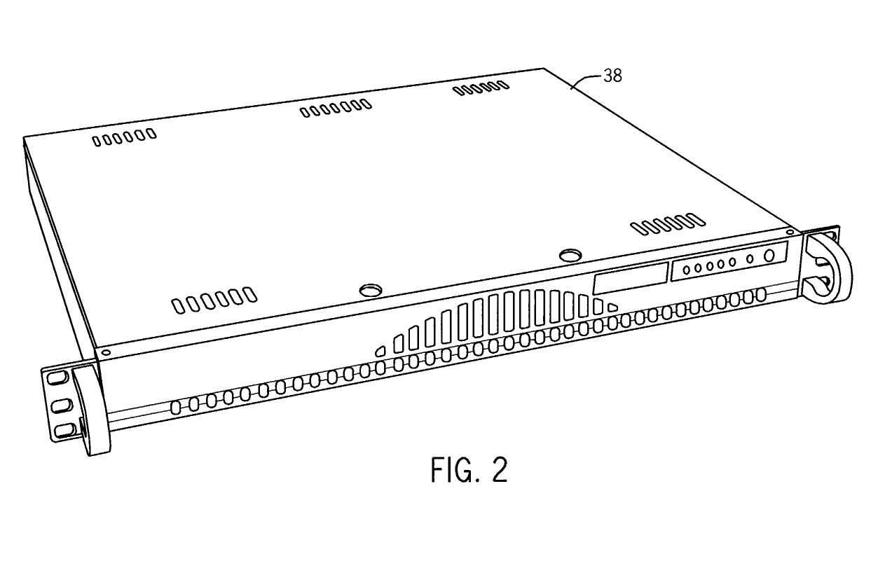

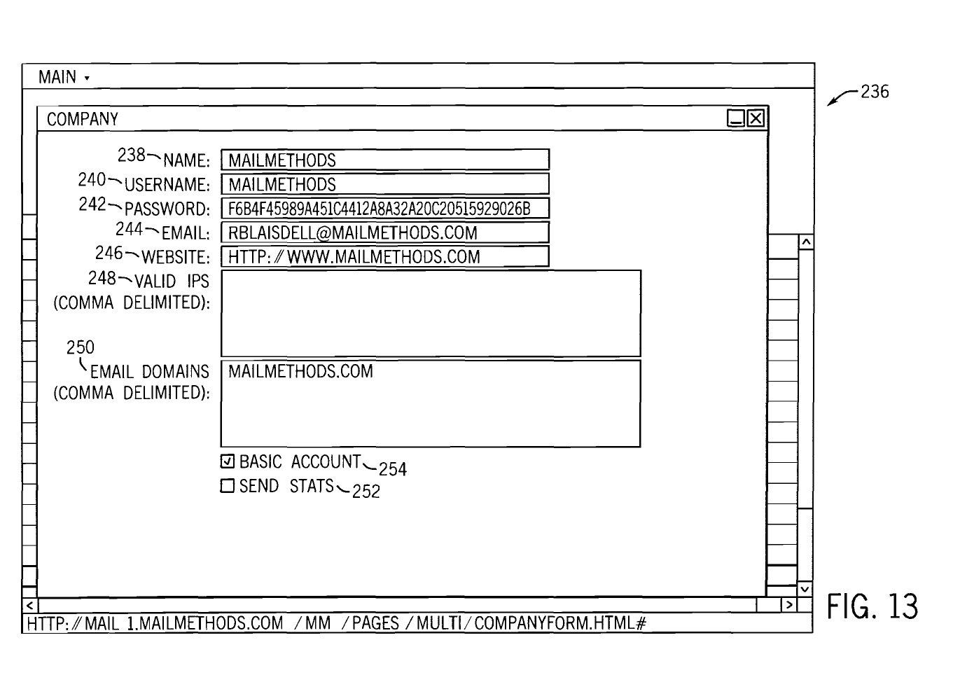

FIG. 2 shows the hardware appliance that is programmed in accordance with the invention to operate as an enhanced advertisement email server 38. The preferred appliance is a Supermicro™ computer appliance from Intel with a 3 GHz processing speed, an 80 GB storage capacity and 1 GB RAM, with the Linux OS operating system. The outgoing email advertisement server 38 is programmed preferably using the JAVA programming language, although other programming languages may be suitable. The server 38 stores electronic advertisements, and banners and footers, as well as logic for advertising campaigns, and also contains tracking and reporting software, as described herein. In the preferred embodiment of the invention, an organization administrator or marketing manager accesses the software online using a web browser to configure the software for a particular organization. In all likelihood, the administrator would first fill out the company set up screen 236 shown in FIG. 13 and described below. Artwork in the form of image files or html files stored on a local computer is downloaded to the outgoing email advertisement server 38 as part of the configuration process, and stored on the server 38 in order for later insertion into outgoing email messages.

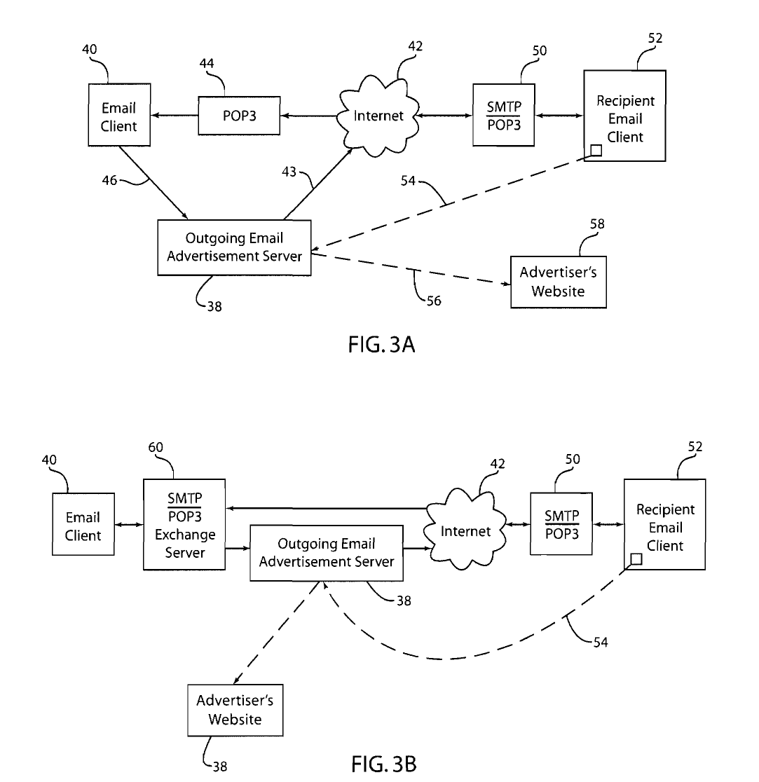

FIGS. 3A and 3B are schematic drawings illustrating the overall physical setup and operation of the invention. In FIG. 3A, an organization's email client 40, such as Microsoft Outlook™, is used to prepare, receive and send email messages. Incoming email messages are transmitted over the internet 42 and typically received by a POP3 server 44, as is known in the art. The email client 40 communicates with the POP3 server to download incoming email messages. In the setup of FIG. 3A, the organization does not have its own exchange server, so outgoing email messages from the email client 40 would normally be sent to a standard SMTP server provided by the internet provider that provides the POP3 server 44 and then transmitted over the internet 42. In accordance with the invention, however, the email client 40 is re-programmed to send outgoing email messages to the outgoing email advertisement server 38, as depicted by arrow 46, instead of a standard SMTP server. The outgoing email advertisement server 38, programmed in accordance with the invention, enhances the plain email message sent from the email client 40 with banners, footers and/or electronic advertisements, and transmits the enhanced outgoing email message 48 over the internet 42 to the intended recipient. Note that in FIG. 3A, the outgoing email advertisement server 38 would typically be programmed to treat received emails from separate domains (or separate organizations) independently. The enhanced email message is received in FIG. 3A by an SMTP/POP 3 server providing internet email service to the recipient. The recipient's email client 52 communicates with the SMTP/POP 3 server 50 to download the enhanced email message. When the recipient opens the enhanced email message with email client software, e.g. Microsoft Outlook™, the recipient views the email message framed with a banner, footer and/or electronic advertisements. Dashed lines 54 and 56 show that the recipient pings off of the outgoing email advertisement server 38 when the recipient selects or “clicks on” electronic advertisement with a cursor and is then directed to the advertiser's website 58. The outgoing email advertisement server 38 in this manner is able to track both all placed electronic advertisements, as well as all converted electronic advertisements.

FIG. 3B schematically illustrates the setup and operation of the invention in a system in which an organization uses a dedicated SMTP/POP3 exchange server 60 through which all incoming and outgoing email is routed. In this configuration, it is preferred that the outgoing email advertisement server 38 piggyback on the exchange server 60 so that all outgoing email messages first pass through the exchange server 60 and then the advertisement server 38. In other respects, the setup is similar to that described in FIG. 3A.

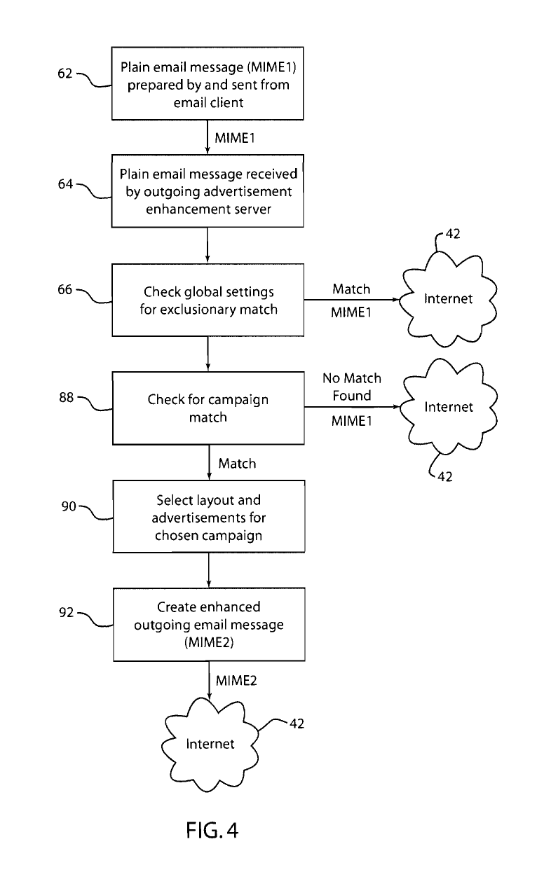

FIG. 4 outlines the functions of the preferred outgoing email server 38. Block 62 indicates that a plain email message (MIME1) is prepared and sent from an email client 40, and block 64 indicates that the plain email message (MIME1) is received by the outgoing email advertisement server 38. Hardware and software techniques for receiving email are well known in the art and do not form a part of the invention. It is important, however, to authenticate the incoming email message, and in particular, determine whether the author, domain and IP address are valid. While the MIME format is most common email format, it may be desirable to enable the system to accept other email formats. A file in MIME format normally includes header information followed by text, images and html data.

Once received and authenticated, the software checks global settings for exclusionary matches, as indicated by box 66. As shown in FIG. 4, if there is an exclusionary match, the original plain email message MIME1 is transmitted from the email advertisement server 38 without enhancement, as indicated, for transmission over the internet 42 to the intended recipient. FIG. 5 shows the preferred global setting setup screen 70. The email address prompt 72 requests the email address for the organization's administrator. The login IP's prompt 74 allows the administrator to select locations from which users can login to utilize the invention. Prompts 76, 78, 80 and 82 prompt the administrator to enter exclusionary keywords or email addresses. For example, FIG. 5 shows that the subject code “noads” is entered in the “never enhance subject code” field 78. Thus, if the author of an email places the code “noads” in the subject line of an outgoing email message, the system will not enhance the outgoing email message and will send a plain email MIME1. Likewise, keywords can be put in the “never enhance subject” field. Also, the “never enhance from” field can be used, for example, to turn off the advertisement enhancement system for all emails sent from a particular email address, such as a company president or legal department. In a similar fashion, the “never enhance to” field can include email addresses for intended recipients to which the email messages are never enhanced with inserted electronic advertisement. It is a matter of choice whether banners and/or footers 26, 28 be placed on all outgoing email messages, even when there is a match of one or more of the exclusionary fields 78, 76, 80 and 82. The global setting screen 70 also includes a prompt 84 labeled “strip HTML” which strips html out of the original message. The screen 70 also includes a prompt 86 entitled “redirect URL” which redirects all URL links directly to the final destination URL without first being directed to the server 38 for tracking purposes.

Referring again to FIG. 4, assuming that there are no exclusionary matches after the global settings are checked, the software then checks the email header information to determine whether there is a campaign match, as indicated by blocks 88. If there is no match, the system sends a plain email message MIME1 to the intended recipient via the internet 42, as indicated in FIG. 4. If there is a match for a particular advertising campaign, the software selects the layout and advertisements for the chosen campaign, as indicated by box 90. Then, the software creates an enhanced outgoing email message (MIME2), as indicated by box 92, which is transmitted to the intended recipient over the internet 42. Beyond the selection of inserted electronic banners, footers and advertisements for insertion into the enhanced email message, the technical creation of the MIME2 file and its specifics use techniques generally known in the art. The enhanced outgoing email message (MIME2) preferably includes header information, followed by the enhanced email in HTML format, the email message in plain text, attached images and inline images in order to make it highly likely that the recipient's email client will recognize both the plain text as well as inserted electronic images and HTML data. Inlining the image means that the web address for the inserted advertisements will appear as a link at the bottom of the email message in the event that the email client does not recognize HTML.

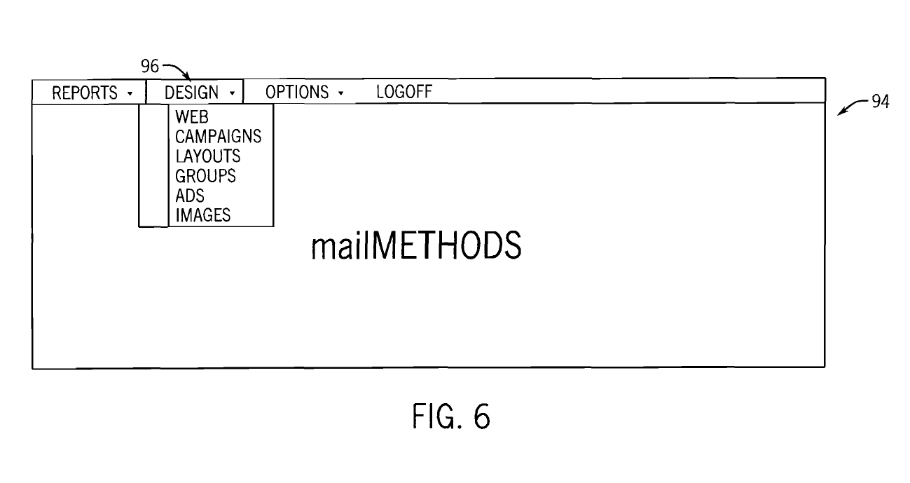

FIG. 6 shows a main menu screen 94 for designing various aspects of an electronic advertising campaign on the outgoing email advertisement server 38. On screen 94, the design prompt 96 preferably includes five submenus: web, campaigns, layouts, groups, ads, and images.

FIG. 7 illustrates the preferred campaigns design screen 98. The name field 100 and the description field 102 are available for the administrator (or marketing manager) to name the particular advertising campaign and provide a description of the campaign. In accordance with one aspect of the invention, campaign selection rules 104 are requested to determine when this particular advertising campaign, i.e. the campaign named “default” in FIG. 7, shall be selected by the software. Under the advertising campaign selection rules 104, there are preferably seven fields: namely, “enhance subject” 106, “enhance subject code” 108, “ignore subject” 110, “enhance from” 112, “enhance to” 114, “ignore from” 116 and “ignore to” 118. Preferably, the software is programmed so that the particular advertising campaign 100 applies only when there is a match for each and every field 106, 108, 110, 112, 114, 116 and 118 unless the field has been left blank, such as the “enhance to” field 114 in FIG. 7. All of the advertising campaigns assigned to a particular company or domain are stored on the server 38 and are tested per the rules 104 in order until the first set of rules is matched, and then that advertising campaign applies. In the example shown in FIG. 7, the advertising campaign named “default” applies whenever the term “new customer” and a subject code “nc1” appear in the subject line of the header and the subject line does not include either the word “collections” or the word “dept”, and the email was sent from anybody in division 1 at the company (see field 112) except for the CEO of the company (see field 116). Finally, the “default” advertising campaign will not be applied if the email is sent to anybody with a domain name at company2 or company3. The prompt 120 labeled “sort order” allows the administrator or marketing manager to enter a priority for the testing order among the various advertising campaigns. In the preferred embodiment, a sort order of 0 puts a particular advertising campaign at the top of the queue, and a sort order of 1 would be below 0 but before 2. The prompt 122 titled “active” enables the administrator to choose whether a particular advertising campaign should be considered within the queue. In other words, advertising campaigns can be stored on the server 38 but be designated as being inactive.

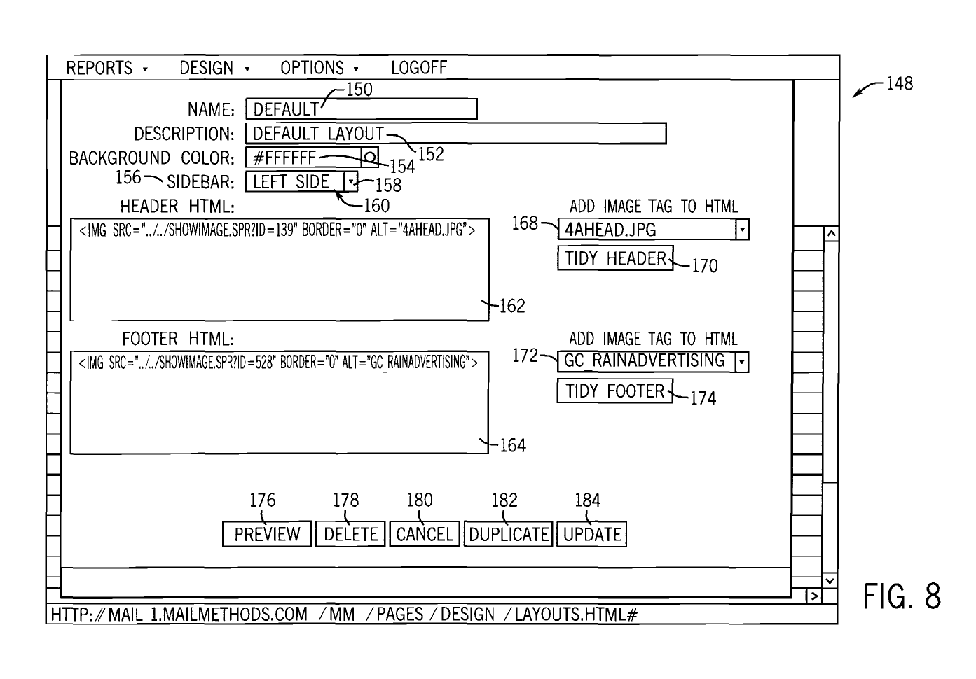

The layout field 124 in FIG. 7 allows the administrator or marketing manager to choose a specific framing layout for the advertising campaign. The design of various layouts is discussed below in connection with FIG. 8.

Still referring to FIG. 7, box 126 contains the strategy for selecting electronic advertisements for insertion into the enhanced outgoing email messages associated with the particular advertising campaign 100. First, the administrator is allowed to select the number of electronic advertising slots, as indicated by field 128 entitled “number of slots”. In the preferred embodiment, the maximum number of slots is five, and the user is allowed to select one, two, three, four or five advertising slots. The strategy for selecting electronic advertisements to be inserted into the respective advertising slots can, in accordance with the preferred embodiment of the invention, can vary as depicted by the chosen strategies 130, 132, 134, 136, 138 in FIG. 7. For the first slot 130 in this particular campaign, the advertisement is being chosen on a static basis. When the static strategy is selected, the same electronic advertisement 130A, labeled “appliance” in FIG. 7, is placed in the first slot for all outgoing email messages enhanced using this particular advertising campaign 100. The advertisement 130A can preferably be selected from all advertisements stored on the outgoing email advertisement server 38 for the organization.

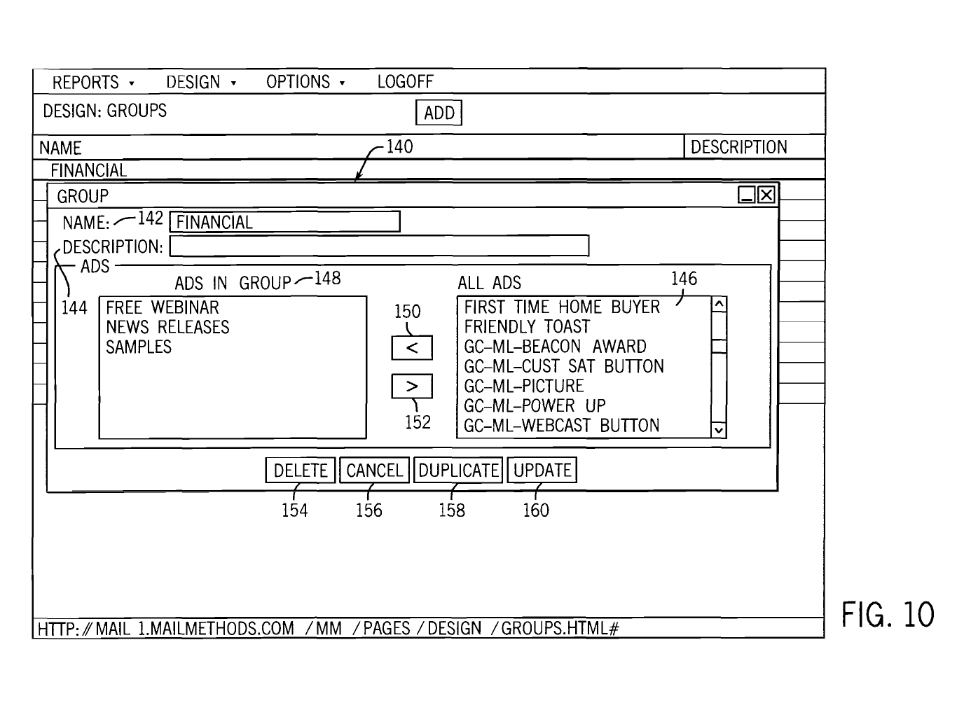

In FIG. 7, the second advertising slot 132 is selected using a rotating strategy. Under the rotating strategy, electronic advertisements are chosen from a group 132A of electronic advertisements on a rotating basis. In FIG. 7, the group 132A of advertisements is entitled “financial”. The preferred group design screen 140 is shown in FIG. 10. Referring briefly to FIG. 10, the screen 140 includes a prompt 142 for the name of the group and a prompt 144 for a description. The screen 140 also provides a window for displaying all advertisements 146 and a window 148 for displaying the advertisements in the group 148. The electronic buttons 150 and 152 are used to add electronic advertisements stored on the system 146 to the group 148, or to remove the advertisements from the group as the case may be. The delete button 154 allows the administrator to delete a group of advertisements, but does not delete the advertisements from the system. The cancel button 156 allows the administrator to cancel programming of the group. The duplicate button 158 allows an administrator to duplicate an existing grouping, and then most likely perform additional editing using buttons 150, 152 on the duplicated group. The update button 160 is used to store a group to the server 38 once the administrator is satisfied with the grouping.

Referring again to FIG. 7, the third advertising slot 134 is selected using the “mail keyword” strategy. More specifically, as discussed in connection with FIGS. 9A-9C, each of the electronic advertisements created and saved on the outgoing email advertisement server 38 may be assigned with one or more keywords. When the mail keyword strategy is selected, the system software searches the content of the outgoing email messages for the keyword or keywords assigned to the electronic advertisements in the selected group 134A of advertisements. In FIG. 7, the selected group of advertisements 134A is entitled the “new look group”. Preferably, the software searches the email text by comparing each word in the email message against the keywords. Preferably, the software searches for the assigned keywords in the text of the outgoing email on the basis of one electronic advertisement at a time beginning with the first advertisement in the queue for the group 134A. Once the software finds a match, it places the assigned electronic advertisement and discontinues further searching, unless the electronic advertisement happens to be a duplicate of one of the advertisements selected for a previous slot 130, 132. The screen 98 in FIG. 7 also shows a default prompt 134B for the mail keyword strategy 134. If the default prompt 134B is chosen, the software will automatically place an advertisement from the group 134 on a rotating basis in the event that there is no keyword match. Note that the fourth slot 136 is programmed the same as the third slot 134 except that the user has not selected the default 136B in case of no match. In this case, the system will normally place only four advertisements in the event that there is no keyword match with any of the electronic advertisements in the group 136A. In the specific case of FIG. 7, the same group is chosen for the third slot 134A and the fourth slot 136A. The software will not place duplicate advertisements, however, as a matter of design choice the software can be made to effectively switch the order of the third and fourth slots for the case shown in FIG. 7 so that it is more likely that five advertisements will be placed instead of only four advertisements.

The fifth slot 138 is shown in FIG. 7 to be programmed in accordance with the “user keyword” strategy. To implement the user keyword strategy 138, the system reads a user database, which includes a listing of prospective email recipients as well as one or more targeting words associated with each prospective recipient email address. Such a file can be prepared manually using spreadsheet or word processing software but can also be exported from elaborate customer identification database systems. In either case, the software selects an advertisement from the group 138A of advertisements selected if a keyword assigned to an electronic advertisement matches one or more of the targeting words listed in the user database for the intended recipient of the email. In this manner, an administrator can target certain types of advertising, for example certain products or product lines, to specific customers. The user keyword strategy 138 also allows the user to select a default in case of no match on a rotating basis, as indicated by 138B, in much the same manner as described above with respect to the mail keyword strategy 134, 136.

Still referring to FIG. 7, the administrator can delete the advertising campaign using the delete button 140, and can cancel an operation using the cancel button 142. For editing purposes, the duplicate button 144 can be used to duplicate an advertising campaign to make a new campaign, and the update button 146 is used to store changes to a particular campaign on the server 38.

FIG. 8 shows a layout design screen 148 in accordance with the preferred embodiment of the invention. The name field 150 and the description field 152 are provided for a name and description for the layout, respectively. The administrator is also preferably prompted 154 for entering background color or pattern. The prompt 156 labeled “sidebar” provides a drop down menu 158 that lists preselected locations 160 for the electronic advertisements in the enhanced email messages. The layout design screen 148 also includes a box 162 containing header HTML information and another box 164 containing footer HTML information. Header HTML information is added into the box 162 using the drop down menu 168 and button 170 appearing on the right side of the screen 148. The drop down menu 168 displays image files which can be added to the header HTML block 162. Footer images are added to the footer HTML 164 in the same manner using the drop down menu 172. The tidy buttons 170 and 174 are used to remove unnecessary code or correct html code in the respective boxes 162, 164. In most circumstances, the images for the header 162 and footer 164 will need to be sized appropriately prior to being added to the layout. The bottom of the screen 148 provides a preview button 176. Note that in the preferred embodiment, the header HTML 162 and the footer HTML 164 are static and remain constant unless reprogrammed by the administrator using screen 148. The bottom of the screen also includes a delete button 178 for deleting a layout, and a cancel button 180 for canceling an operation. The bottom of the screen further includes a duplicate button 182 and an update button 184 having the functions similar to those described with respect to earlier screens.

FIGS. 9A-9C show the preferred screens 186, 188 and 190 for designing electronic advertisements and storing the advertisements on the outgoing email advertising server 38. Referring to FIG. 9A, screen 186 is for developing a text advertisement. The screen 186 includes a name field 192 and a description field 194 for entering the name and description of the electronic text advertisement. The screen 186 also includes a keywords prompt 196. The administrator enters one or more keywords 198, 200, 202 in response to the prompt 196. These keywords 198, 200 and 202 are assigned to this particular advertisement 192. In other words, as described above with respect to FIG. 7, the keywords 198, 200, 202 are used for keyword searching the text of the outgoing email message if the “mail keyword” strategy 134 or 136 is chosen, and are used to determine a match in the user database with a targeting word for a particular recipient if the “user keyword” strategy 138 is used. Towards the lower portion of the screen 186 in FIG. 9A, the administrator enters a headline 204 for the text advertisement, and a first and second line 206, 208 for the advertisement. The screen 186 also displays a prompt 210 for entering a destination URL associated with the text advertisement 192. In the example shown in FIG. 9A, there is no URL associated with the advertisement, and instead the screen 186 has been programmed in accordance with the “use landing page” feature 2012. The box 214 titled “landing page text” contains text that can be entered by the administrator to provide a landing page, stored on the server 38, which appears when the recipient of this email advertisement selects or “clicks on” this advertisement. Still referring to FIG. 9A, the bottom of the screen 186 includes a cancel button 216 and an add button 218. The cancel button 216 cancels the programming of the text advertisement at hand and clears the screen. The add button 218 stores the text advertisement 192 on the server 38 for later use by this particular company or organization in advertising campaigns.

FIG. 9B shows an image ad design screen 188, which in many ways is similar to the text advertisement design screen 186 shown in FIG. 9A. For example, the image advertisement design screen 188 includes a prompt 192 for entering the name of the advertisement, a prompt 194 for entering a description, a prompt 196 for entering keywords, and an option 212 to select the use of a landing page, all which are preferably similar in operation to that described with respect to the text advertisement design screen 186 in FIG. 9A. The image ID prompt 219 provides a field 220 for loading the image for the electronic advertisement. This image would have typically been already uploaded to the server 38. The prompt 222 labeled “alt text” prompts the user to enter some alternative text which will be displayed adjacent the image in the electronic advertisement. The prompt 217 is labeled “destination URL” and prompts the user to enter the final destination URL for which the user will be directed upon selecting or “clicking on” the electronic advertisement in the received enhanced email message. The cancel button 216 and add button 218 have the same function as described in connection with FIG. 9A,

Referring to FIG. 9C, the software also preferably allows the design of HTML advertisements. Screen 190 in FIG. 9C shows the preferred HTML design screen. Again, the screen 190 includes prompts 192, 194 and 196 for entering name, description and keywords, as well as a cancel button 216 and add button 218, all having similar functions that are described in the above FIGS. 9A-9B. The screen 190 includes an add image tag prompt 224 and there is a drop list 226 opposite the prompt 224 for displaying image files. These images files would typically have been uploaded to the server 38. The block 228 labeled “HTML” contains HTML code for the advertisement. The tidy button 230 removes unnecessary html code and corrects errors from the code in box 228.

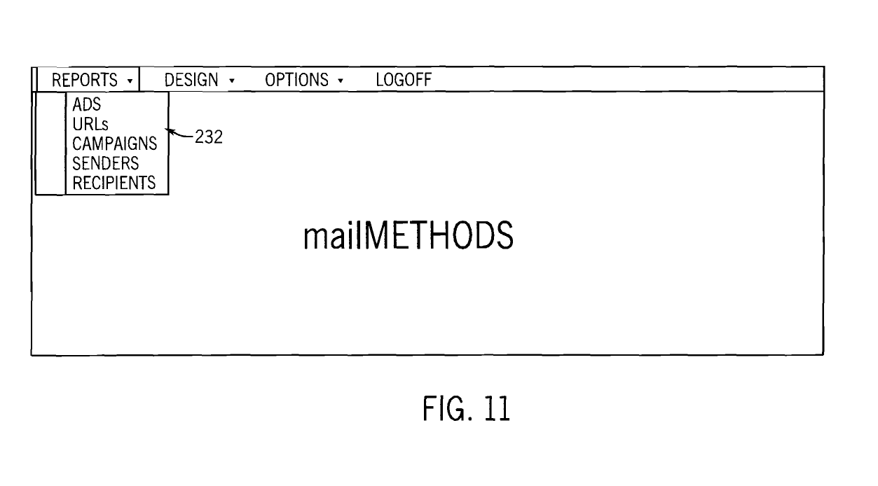

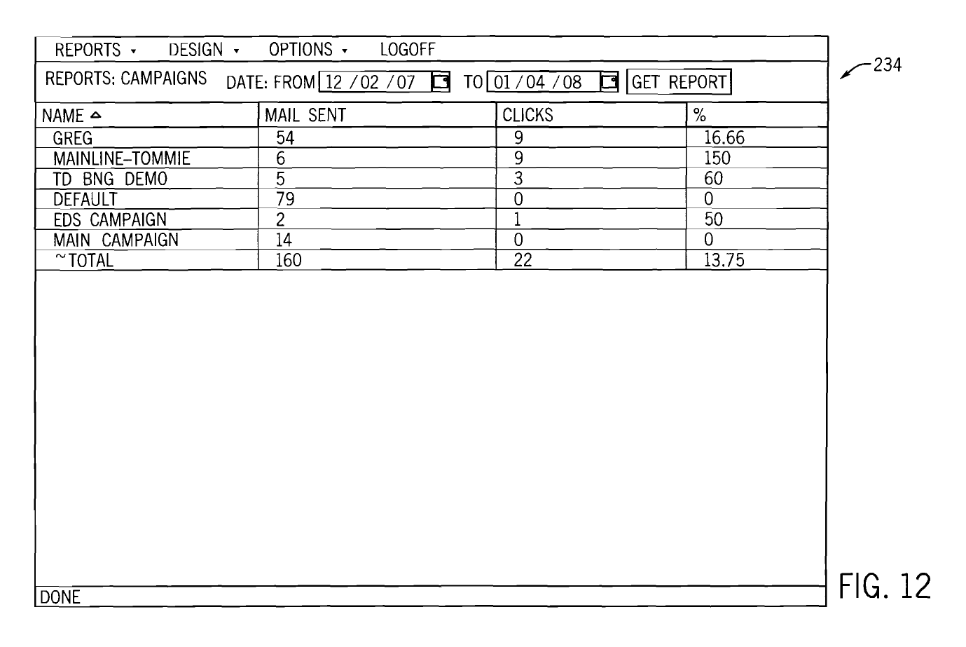

As mentioned previously, the preferred system can track the placement of advertisements as well as the conversion or click-through of advertisements. FIG. 11 is a main screen of the preferred embodiment of the invention showing the reports pull down menu, which allows the reports to be sorted by advertisement, URLs, campaign senders or recipients. FIG. 12 is an image of a typical reports screen 234, and shows a report for the listed advertising campaigns between certain dates.

FIG. 13 shows the preferred company setup screen 236. The screen 236 provides a prompt for entering a name of the company 238, as well as the user name 240 and a password 242. The screen 236 also includes a prompt 244 for entering the email address for the administrator or marketing manager in charge of operating and programming the software as well as a prompt for entering the company or organization's website URL address. The box 248 entitled “valid IPs” allows the entry of IP addresses through which employees of the company or organization are able to use the system. Box 250 entitled “email domains” is for limiting the email domains for which employees of the company or organization are able to use the system. The bottom of the company setup screen 236 includes a send stats box 252 which if checked activates an option to automatically send reports to the company at the email address 244 entered above on the screen. The screen 236 also provides a prompt 254 entitled “basic account” which if checked allows the company to use a simplified system of layout and advertisement placement.

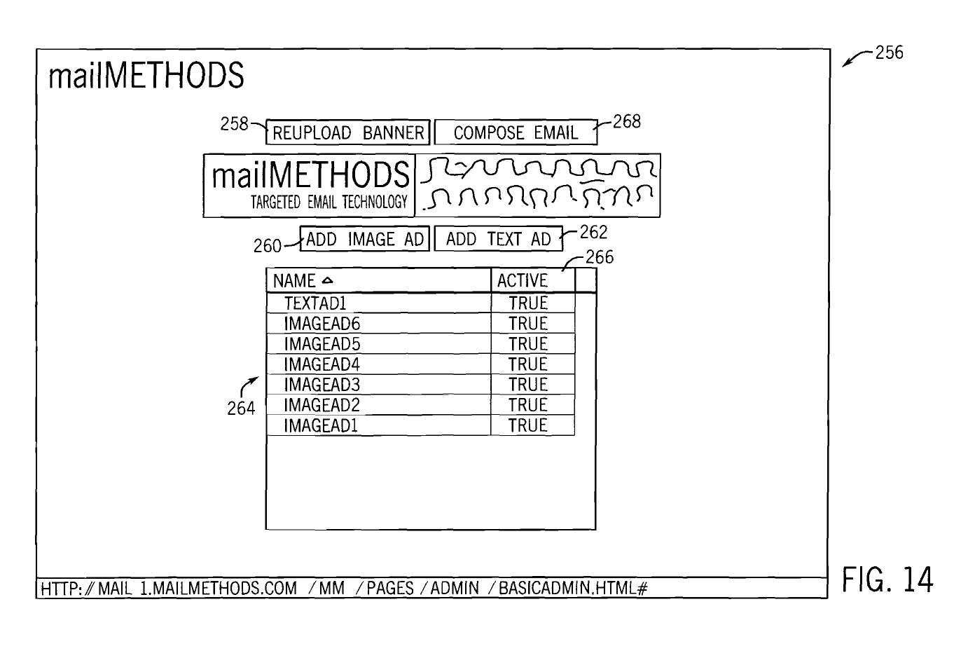

FIG. 14 shows the basic account setup screen 256 which appears if a company or organization is setup as a basic account, see prompt 254 in FIG. 13. When an account is designated as a basic account, the system automatically assigns a layout and an advertising campaign strategy. The preferred layout includes a banner at the top and a maximum of five electronic advertisements placed along a left hand sidebar. In FIG. 14, the basic account setup screen includes a re-upload banner button 258 which is used to upload artwork for a banner similar to the process described in connection with FIG. 8, but simplified. An “add image ad” button 260 and an “add text ad” button 262 are also provided. The add image ad button 260 accesses the image advertisement design screen 188 (FIG. 9B) and add text ad button 262 accesses the text advertisement design screen 186 (FIG. 9A) for designing electronic advertisements and assigning the advertisements keywords, as described above. The advertisements are then added to a single grouping of advertisements 264. Each advertisement can be flagged as being active or inactive, see reference numeral 266. The user or administrator can then choose the compose email button 268 to exit the setup screen 256. Preferably, the basic account uses a single campaign strategy, and in particular, it has been found desirable to use the “mail keyword” strategy with a default being the selection of another electronic advertisement on a rotating basis, as disclosed in FIG. 7, reference numbers 134 and 134B. Duplicate advertisements are not placed, and less than five advertisements are placed if there are less than five advertisements stored on the system for the company.

The figures illustrate an embodiment of the invention which is exemplary in nature and not intended to limit the invention. For example, while the above description refers to original email messages being prepared manually, it should be understood the outgoing email could be generated automatically, e.g., by an alert system or an email confirmation system, in which case the system automatically generating and sending the email messages would be considered an email client for purposes of this invention.

We claim:

1. A method of selecting electronic advertisements for and inserting selected advertisements into outgoing email messages, the method comprising the steps of:
preparing a plain email message with an email client;
sending the plain email message from the email client;
receiving the plain email message by an outgoing mail server;
storing at least one advertising campaign containing a plurality of electronic advertisements on the outgoing mail server;
assigning at least one keyword to at least one of the electronic advertisements on the outgoing server;
searching the content of the plain email message for the assigned keyword;
creating an enhanced outgoing email message in which the original content of the plain email message is supplemented with at least the electronic advertisement to which the keyword is assigned if the keyword appears in the plain email message received by the outgoing email server; and
sending the enhanced email message from the outgoing email server to an intended recipient.

2. A method as recited in claim 1 where, in the absence of any assigned keyword in the content of the original plain email message, the enhanced outgoing email message is created by supplementing the content of the original plain email message with another electronic advertisement in the campaign.

3. A method as recited in claim 1 further comprising the steps of:
providing a user database containing an email address for prospective email recipients along with one or more targeting words;
determining whether the email message is being sent to a prospective email recipient listed in the user database, and if so determining whether the one or more targeting words associated with recipient email address match the assigned keyword; and
wherein the step of creating an enhanced outgoing email message further comprises supplementing the original content of the plain email message with at least the electronic advertisement to which the keyword is assigned if the keyword matches one or more of the targeting words listed in the user database for the intended recipient.

4. A method as recited in claim 3 where, in the absence of a match with any assigned keyword and any targeting words listed in the user database for the intended recipient, the enhanced outgoing email message is created by supplementing the content of the original plain email message with another electronic advertisement in the campaign.

5. A method as recited in claim 1 further comprising the steps of:
selecting at least one electronic advertisement to be static; and
wherein the step of creating an enhanced outgoing email message further comprises supplementing the original content of the plain email message with at least the static electronic advertisement.

6. A method as recited in claim 1 further comprising the steps of:
selecting a plurality of electronic advertisements to be in a group; and
wherein the step of creating an enhanced outgoing email message further comprises supplementing the original content of the plain email message with at least one of the electronic advertisements in the group on a rotating basis.

7. A method as recited in claim 1 wherein the outgoing server is an smtp server which receives the plain email message directly from the email client.

8. A method of selecting electronic advertisements for and inserting selected advertisements into outgoing email messages, the method comprising the steps of:
preparing a plain email message with an email client;
sending the plain email message from the email client;
receiving the plain email message by an outgoing mail server;
storing at least one advertising campaign containing a plurality of electronic advertisements on the outgoing mail server;
assigning at least one keyword to at least one of the electronic advertisements on the outgoing server;
providing a user database containing an email address for prospective email recipients along with one or more targeting words;
determining whether the email message is being sent to a prospective email recipient listed in the user database, and if so determining whether the one or more targeting words associated with recipient email address match the assigned keyword;
creating an enhanced outgoing email message in which the original content of the plain email message is supplemented with at least the electronic advertisement to which the keyword is assigned if the keyword matches one or more of the targeting words listed in the user database for the intended recipient; and
sending the enhanced email message from the outgoing email server to an intended recipient.

9. A method as recited in claim 8 wherein the user database is exported from a customer identification system into a comma, delimited text file with targeting word and email addresses prior to being read by software on the outgoing email server implementing the recited invention.

10. A method of preparing electronic advertisements for insertion into enhanced outgoing email messages and displaying the prepared electronic advertisements, the method comprising the steps of:
providing an option to associate a destination URL with a prepared advertisement, which directs a recipient to the destination URL if a recipient selects the advertisement after the enhanced email has been delivered to the recipient;
providing an alternative option to associate a landing page with a prepared advertisement, which directs a recipient to the landing page if a recipient selects the advertisement after the enhanced email has been delivered to the recipient;
preparing one or more images and/or text that are displayed in an enhanced email messages in which electronic advertising is inserted into outgoing email messages,
selecting the option to associate a landing page with the prepared advertisement,
preparing a landing page comprising one or more images and/or text which are associated with the prepared advertisement; and
displaying the landing page when the email recipient selects the advertisement after the enhanced email has been delivered to the recipient.
